(19) United States
(12) Patent Application Publication
(10) Pub. No.: US 2008/0070465 A1
(43) Pub. Date: Mar. 20, 2008

(54) High loft nonwoven for foam replacement

(76) Inventor: Thomas Cobbett Wiles, Easley, SC (US)

Correspondence Address: Legal Department (M-495), P.O. Box 1926, Spartanburg, SC, 29304, US

(21) Appl. No.: 11/522,711

(22) Filed: Sep. 18, 2006

(51) Int. Cl. D04H 1/00; B32B 3/00; B32B 27/12

(52) U.S. Cl. 442/352; 442/364; 442/415; 442/338; 442/394; 428/172

(57) ABSTRACT

The invention relates to a high loft nonwoven composite comprising a nonwoven layer having a first and second side and a thermoplastic layer. The nonwoven layer comprises about 60 to 90% by weight of a high crimp polyester fiber having between about 5 and 20 crimps per inch and about 10 to 40% by weight of a core/sheath polyester fiber, where the sheath has a lower melting temperature than the core. The nonwoven layer is calendared on at least the first side. A thermoplastic layer is applied to the first side of the nonwoven layer.

### FIELD OF THE INVENTION

The present invention generally relates to high loft nonwoven composites, and in particular, to high loft nonwoven composites for use as foam replacements.

### BACKGROUND

Transportation vehicles such as cars, trucks, etc., typically have doors and seats which are covered with some form of durable material designed to withstand a variety of forces. Common materials for the platform of such vehicle seats include leather and cloth, such as woven fabrics, knit fabrics and the like. In the case of cloth seats, the fabrics used are typically selected to be heavy and highly decorative and are many times backed with polyurethane foam. The remaining portions of the vehicle seats are collectively referred to herein as the seating trim which are typically made from vinyl material backed with urethane foam, even where natural leather has been used to form the seat platform.

Some considerations that vehicle seating fabric manufacturers must take into account when designing the fabrics are the particular physical parameters which must be achieved. For example, the materials must have at least minimal resistance to UV degradation, in order that they can withstand extended periods of direct sunlight. Furthermore, if the fabrics are formed from a plurality of laminated layers, they generally must have at least minimum lamination bond strength to reduce peeling and separation of the layers. In addition, the performance characteristics of the platform materials must be retained throughout a wide range of temperatures and temperature changes, since vehicles can heat up rapidly in the sun and become extremely cold in response to frigid external temperatures.

It would be desirable to have an alternative to the foam backing with a material with some of the same elastomeric and foam-like compressibility and resilience characteristics of foam, but would use no blowing agents and are more environmentally friendly if incinerated.

### BRIEF DESCRIPTION OF THE DRAWINGS

An embodiment of the present invention will now be described by way of example, with reference to the accompanying drawings.

FIG. 1 is a cross-sectional schematic of one embodiment of the high loft nonwoven composite.

FIG. 2 is a cross-sectional schematic of a second embodiment of the high loft nonwoven composite.

FIG. 3 is a cross-sectional schematic of a third embodiment of the high loft nonwoven composite.

### DETAILED DESCRIPTION

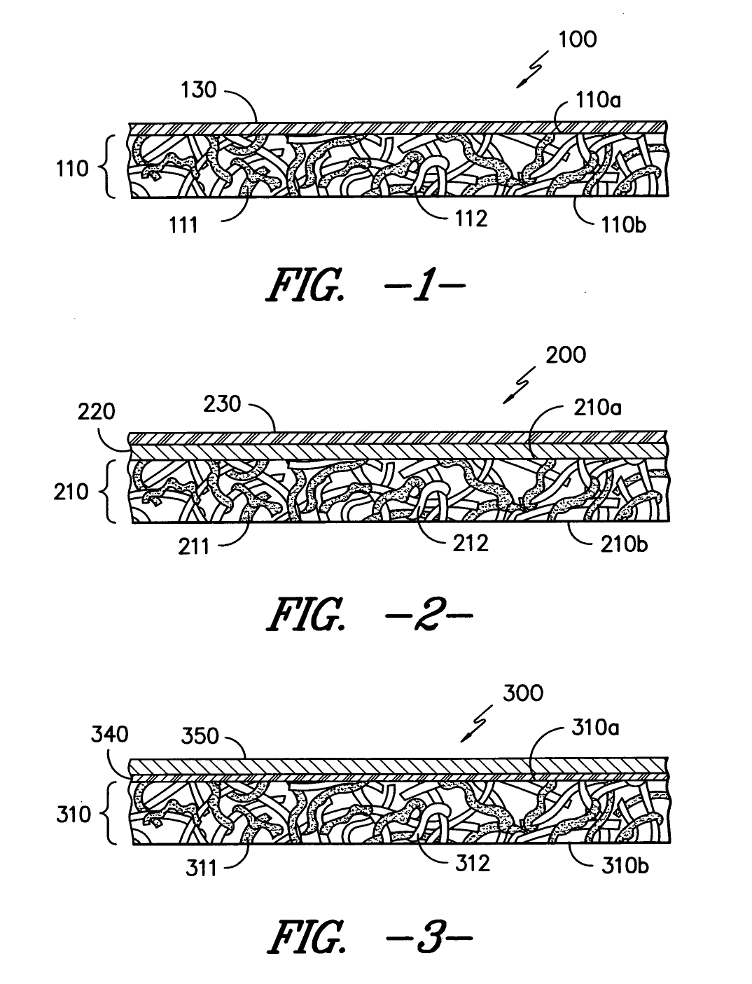

Referring to FIG. 1, there is shown a high loft nonwoven composite 100. The high loft nonwoven composite 100 generally includes a nonwoven layer 110 and a thermoplastic layer 130. The nonwoven layer 110 is formed from high crimp polyester fibers 111 and core/sheath polyester fibers 112. The nonwoven layer 110 is calendared on at least the first side 110a of the nonwoven layer 110. A thermoplastic layer 130 is adhered to the first side 110a of the nonwoven layer 110.

The high crimp polyester fibers 111 make up between about 60 and 90% by weight of the nonwoven layer 110 and have between about 5 and 20 crimps per inch (about 2 and 7.9 crimps per cm). Preferably, the high crimp polyester fibers 111 are hollow fibers giving the nonwoven layer 110 loft and reduced weight. In one embodiment, the high crimp polyester fibers 111 are between about 2 and 15 denier, more preferably 6 and 8 denier. In one embodiment, the staple length of the high crimp polyester fibers 111 is between about 1 and 4 inches (about 2.54 and 10.2 cm). It is generally preferred to add a silicon containing finish to the high crimp polyester fibers 111 to impart desired physical parameters such as enhanced feel.

The core/sheath polyester fibers 112 of the nonwoven layer 110 acts as a binder fiber for the nonwoven layer 110 and are found in an amount of between about 10 and 40% by weight in the nonwoven layer 110. The sheath of the core/sheath polyester fibers 112 has a lower melting temperature than the core, the sheath preferably having a melting temperature of between about 90 and 110° C. The core/sheath polyester fibers 112 preferably are from deniers about 1 to 15 with staple length between about 1 and 4 inches.

The nonwoven layer 110 formed by blending, carding, cross lapping, and needling the high crimp polyester fibers 111 and the core/sheath polyester fibers 112. In one embodiment, the nonwoven layer 110 is needled about 200 to 800 times per square centimeter and may be elliptically needled. The nonwoven layer 110 preferably has a density of between about 0.65 and 4.0 g/cm3 and a thickness of between about 2 and 10 mm. Once the nonwoven layer 110 is formed, the nonwoven layer 110 is calendared on at least the first side 110a. In another embodiment, the nonwoven layer 110 is calendared on both the first side 110a and the second side 110b. Calendaring the nonwoven layer 110 serves to heat the nonwoven layer 110 and melt the sheath of the core/sheath polyester fibers 112 which bond to the high crimp polyester fibers 111. When only the first side 110a is calendared, more heat is applied to the first side 110a and more of the sheaths of the core/sheath polyester fibers 112 melt and this serves to form a smoother surface on the calendared side. Having a smooth side is advantageous for coating or applying subsequent layers on to the first side 110a of the nonwoven layer 110.

Still referring to FIG. 1, a thermoplastic layer 130 is applied to the first side 110a of the nonwoven layer 110. The thermoplastic layer 130 may be a layer or a film applied to the nonwoven layer 110. In one embodiment, fibers from the nonwoven layer 110 are embedded into the thermoplastic layer 130. The thermoplastic layer 130 preferably is a thermoplastic olefin (TPO), polyvinyl chloride (PVC), polyurethane, or the like. Preferably, the thermoplastic is embossed. In one embodiment, the thermoplastic layer 130 is embossed with a leather simulation pattern. The thermoplastic layer 130 may be applied to the nonwoven layer 110 by any known method, including but not limited to extrusion coating, extrusion lamination, hot melt lamination, pressure sensitive lamination, and use of an adhesive powder, scrim, or coating liquid.

Referring now to FIG. 2, there is shown another embodiment of the high loft nonwoven composite 200. The composite 200 generally includes a nonwoven layer 210, a fabric substrate 220 on a first side 210a of the nonwoven layer 210, and a thermoplastic layer 230 on the fabric substrate 220.

The high crimp polyester fibers 211 make up between about 60 and 90% by weight of the nonwoven layer 210 and have between about 5 and 20 crimps per inch (about 2 and 7.9 crimps per cm). Preferably, the high crimp polyester fibers 211 are hollow fibers giving the nonwoven layer 210 loft and reduced weight. In one embodiment, the high crimp polyester fibers 211 are between about 2 and 15 denier, more preferably between about 6 and 8 denier. In one embodiment, the staple length of the high crimp polyester fibers 211 is between about 1 and 4 inches. It is generally preferred to add a silicon containing finish to the high crimp polyester fibers 211 to impart desired physical parameters such as enhanced feel.

The core/sheath polyester fibers 212 of the nonwoven layer 210 acts as a binder fiber for the nonwoven layer 210 and are found in an amount of between about 10 and 40% by weight in the nonwoven layer 210. The sheath of the core/sheath polyester fibers 212 has a lower melting temperature than the core, the sheath preferably having a melting temperature of between about 90 and 110° C. The core/sheath polyester fibers 112 preferably are from deniers 1 to 15 with staple length between 1 and 4 inches.

Still referring to FIG. 2, the nonwoven layer 210 formed by blending, carding, cross lapping, and needling the high crimp polyester fibers 211 and the core/sheath polyester fibers 212. In one embodiment, the nonwoven layer 210 is needled about 200 to 800 times per square centimeter and may be elliptically needled. The nonwoven layer 210 preferably has a density of between about 0.65 and 4.0 g/cm3 and a thickness of between about 2 and 10 mm. Once the nonwoven layer 210 is formed, the nonwoven layer 210 may be heat set. This heat setting may be in the form of calendaring or applying heat to one or both sides (210a and/or 210b) of the nonwoven layer 210 to melt the sheath of the core/sheath polyester fibers 212 which bond to the high crimp polyester fibers 211.

The fabric substrate 220 is needled onto the first side 210a of the nonwoven layer 210. The fabric substrate 220 is a knit, woven, or nonwoven fabric. If the fabric substrate 220 is a nonwoven, the nonwoven may include a spun bond, spun lace, needle punch, air laid, wet laid, pattern bond nonwoven. The fabric substrate 220 may be made of any natural or man-made fibers suitable to the composite, including polyester, cotton, polyester/cotton blends, nylon, polyarylenes, olefin fibers such as polyethylene and polypropylene, FR (fire resistant) fibers such as modacrylic, Visil™ (silica modified rayon), partially oxidized acrylonitrile (PAN), spandex yarns, rayon, and FR treated yarns of above. The yarns may be monofilament, multifilament, or staple. The needling of the fabric substrate 220 to the nonwoven layer 210 may be through the fabric substrate 220 to the nonwoven layer 210, from the nonwoven layer 210 to the fabric substrate 220, or both. In one embodiment, the needling is performed from the nonwoven layer 210 into the fabric substrate 220, pushing and embedding the fibers from the nonwoven layer 210 into the fabric substrate 220 to join them. The composite of the nonwoven layer 210 and the fabric substrate 220 needled together may be heat set one or both sides.

Still referring to FIG. 2, a thermoplastic layer 230 is applied to the side of the fabric substrate 220 on its side opposite the nonwoven layer 210a. The thermoplastic layer 230 may be a layer or a film applied to the fabric substrate 220. In one embodiment, fibers from the fabric substrate 220 embed into the thermoplastic layer 230. The thermoplastic layer 230 preferably is a thermoplastic olefin (TPO), polyvinyl chloride (PVC), polyurethane, or the like. Preferably, the thermoplastic is embossed with a leather simulation pattern. The thermoplastic layer 230 may be applied to the fabric substrate 220 is any known method, including but not limited to extrusion coating, extrusion lamination, hot melt lamination, pressure sensitive lamination, and use of an adhesive powder, scrim, or coating liquid.

Referring now to FIG. 3, there is shown another embodiment of the high loft nonwoven composite 300. The composite 300 generally includes a nonwoven layer 310, a binder layer 340, and a surface textile 350 on a first side 310a of the nonwoven layer 310.

The high crimp polyester fibers 311 of the nonwoven layer 310 make up between about 60 and 90% by weight of the nonwoven layer 310 and have between about 5 and 20 crimps per inch (about 2 and 7.9 crimps per cm). Preferably, the high crimp polyester fibers 311 are hollow fibers giving the nonwoven layer 310 loft and reduced weight. In one embodiment, the high crimp polyester fibers 311 are between about 2 and 15 denier, more preferably 6 and 8 denier. In one embodiment, the staple length of the high crimp polyester fibers 311 is between about 1 and 4 inches. It is generally preferred to add a silicon containing finish to the high crimp polyester fibers 311 to impart desired physical parameters such as enhanced feel.

The core/sheath polyester fibers 312 of the nonwoven layer 310 acts as a binder fiber for the nonwoven layer 310 and are found in an amount of between about 10 and 40% by weight in the nonwoven layer 310. The sheath of the core/sheath polyester fibers 312 has a lower melting temperature than the core, the sheath preferably having a melting temperature of between about 90 and 110° C. The core/sheath polyester fibers 312 preferably are from deniers 1 to 15 with staple length between 1 and 4 inches.

Still referring to FIG. 3, the nonwoven layer 310 formed by blending, carding, cross lapping, and needling the high crimp polyester fibers 311 and the core/sheath polyester fibers 312. In one embodiment, the nonwoven layer 210 is needled about 200 to 800 times per square centimeter and may be elliptically needled. The nonwoven layer 310 preferably has a density of between 0.65 and 4.0 g/cm3 and a thickness of between 2 and 10 mm. Once the nonwoven layer 310 is formed, the nonwoven layer 310 is heat set. This heat setting may be in the form of calendaring or applying heat to one or both sides (310a and/or 310b) of the nonwoven layer 310 to melt the sheath of the core/sheath polyester fibers 312 which bond to the high crimp polyester fibers 311.

A binder layer 340 is applied to the first side 310a of the nonwoven layer 310. The binder layer 340 is preferably an adhesive, including a hot melt, pressure sensitive, UV cured, or other adhesives. The binder layer 340 may be applied as a coating, powder, film, adhesive coated scrim, or other known methods including extrusion coating, extrusion lamination, hot melt lamination, pressure sensitive lamination, and use of an adhesive powder, scrim, or coating liquid. In one embodiment, the binder is a polyolefin that is extruded onto the nonwoven layer 310.

A surface textile 350 is applied to the binder layer 340 on the side of the binder layer 340 opposite the nonwoven layer 310. The surface textile 350 is a knit, woven, or nonwoven fabric, including a warp and circular knit. The surface textile 350 may be made of any natural or man-made fibers suitable to the composite, including polyester, cotton, polyester/cotton blends, nylon, polyarylenes, olefin fibers such as polyethylene and polypropylene, FR (fire resistant) fibers such as modacrylic, rayon, Visil™ (silica modified rayon), partially oxidized acrylonitrile (PAN), spandex yarns, and FR treated yarns of above. The yarns may be monofilament, multifilament, or staple. The surface textile 350 is typically referred to in the automobile textile art as an “A” surface textile 350 meaning that it is the outermost layer of the composite it the layer that is viewed and touched by the consumer. The “A” surface textile 350 typically has a pattern and may have a certain feel or other physical characteristics. The surface textile 350 is held to the nonwoven layer 310 by the binder layer 340. The bonder layer 340 and the surface textile 350 may be applied to the nonwoven layer 310 separately or at the same time, or the binder layer 340 may actually first be coated onto the surface textile 350 and then the combination is applied to the nonwoven layer 310. In one embodiment, the binder layer 340 is a hot melt adhesive and the adhesive is applied to the nonwoven layer 310 and the textile substrate 350 is applied to the binder layer 340 before the binder layer 340 cools.

### EXAMPLES

Example 1 was a high loft nonwoven composite as illustrated in FIG. 1. The nonwoven layer had 80% by weight of a high crimp, hollow, polyester fiber having a denier of 7, a staple length of 2.5 inches, and 11.4 crimps per inch. This fiber was available from Barnett and sons. The nonwoven layer had 20% by weight of a core/sheath polyester fiber having a denier of 4, a staple length of 2 inches. This fiber was available from Barnett and sons and the sheath had a melting temperature of 90-110° C. The high crimp polyester fibers and the core/sheath polyester fibers were carded, crosslapped, and needling (with 414 needles per square cm) to form a nonwoven layer with a density of 1.3 g/cm³ and a thickness of 5.1 mm.

After the nonwoven layer was formed, it was calendared on a first side by rotating the nonwoven layer around a heated drum for approximately 5-10 seconds. This melted the sheaths of the core/sheath polyester fibers and bonded them to the high crimp polyester fibers giving the nonwoven layer resiliency.

A thermoplastic layer was then coated onto the first side of the nonwoven layer. The thermoplastic layer was a TPO layer extrusion coated onto the nonwoven layer in a thickness of 15 mils (approximately 375 μm). This thermoplastic layer was embossed with a leather simulation pattern.

Example 2 was a high loft nonwoven composite as illustrated in FIG. 2. The nonwoven layer had 80% by weight of a high crimp, hollow, polyester fiber having a denier of 7, a staple length of 2.5 inches, and 11.4 crimps per inch. This fiber was available from Barnett and sons. The nonwoven layer had 20% by weight of a core/sheath polyester fiber having a denier of 4, a staple length of 2. This fiber was available from Barnett and sons and the sheath had a melting temperature of 90-110° C. The high crimp polyester fibers and the core/sheath polyester fibers were carded, crosslapped, and needling (with 414 needles per square cm) to form a nonwoven layer with a density of 1.3 g/cm³ and a thickness of 5.1 mm.

After the nonwoven layer was formed, it was heat set by calendaring the nonwoven layer on a first side by rotating the nonwoven layer around a heated drum for approximately 5-10 seconds. This melted the sheaths of the core/sheath polyester fibers and bonded them to the high crimp polyester fibers giving the nonwoven layer resiliency.

A knit fabric was needled onto the first side of the nonwoven layer. The knit fabric was a circular knit type knit formed from 150 denier polyester yarns. The knit fabric was needled onto the nonwoven layer by needling from the nonwoven layer into the knit layer. This caused a portion of the fibers of the nonwoven layer to become embedded and tangled with the knit layer. While in this example the nonwoven layer was calendared before needling the knit layer to the nonwoven layer, the knit/nonwoven composite could have been calendared on one or both sides after needling the two layers together.

A thermoplastic layer was then coated onto the knit layer (on the side opposite the nonwoven layer). The thermoplastic layer was a TPO layer extrusion coated onto the nonwoven layer in a thickness of 15 mils. This thermoplastic layer was embossed with a leather simulation pattern.

Example 3 was a high loft nonwoven composite as illustrated in FIG. 3. The nonwoven layer had 80% by weight of a high crimp, hollow, polyester fiber having a denier of 7, a staple length of 2.5 inches, and 11.4 crimps per inch. This fiber was available from Barnett and sons. The nonwoven layer had 20% by weight of a core/sheath polyester fiber having a denier of 4, a staple length of 2. This fiber was available from Barnett and sons and the sheath had a melting temperature of 90-110° C. The high crimp polyester fibers and the core/sheath polyester fibers were carded, crosslapped, and needling (with 414 needles per square cm) to form a nonwoven layer with a density of 1.3 g/cm³ and a thickness of 5.1 mm.

After the nonwoven layer was formed, it was heat set by calendaring the nonwoven layer on a first side by rotating the nonwoven layer around a heated drum for approximately 5-10 seconds. This melted the sheaths of the core/sheath polyester fibers and bonded them to the high crimp polyester fibers giving the nonwoven layer resiliency.

A bonding layer was applied to the first side of the nonwoven layer. The adhesive used as the bonding layer was an adhesive webbing available from Spunfab Corporation as part number VI-6010.

A surface textile was then applied to the bonding layer (on the side opposite the nonwoven layer). The surface textile used was an “A” surface automotive grade knit fabric available from Milliken and Company as Abyss™.

Each of the 3 samples were tested as door panel ornamentals as a replacement for the current foam based products. The 3 nonwoven based composites had better compressibility properties than the foam based products and in addition, they are less prone to decomposition, more environmentally friendly if incinerated, and may be more recyclable then the foam based door panel ornamentals.

The invention has been described in detail with particular reference to certain preferred embodiments thereof, but it will be understood that variations and modifications can be effected within the spirit and scope of the invention.

1. A high loft nonwoven composite comprising:
a nonwoven layer having a first and second side comprising
about 60 to 90% by weight of a high crimp polyester fiber having between about 5 and 20 crimps per inch, and
about 10 to 40% by weight of a core/sheath polyester fiber, wherein the sheath has a lower melting temperature than the core,
wherein the nonwoven layer is calendared on at least the first side; and,
a thermoplastic layer applied to the first side of the nonwoven layer.

2. The high loft nonwoven composite of claim 1, wherein the high crimp polyester fibers are hollow.

3. The high loft nonwoven composite of claim 1, wherein the high crimp polyester fiber further includes a silicon containing coating.

4. (canceled)

5. The high loft nonwoven composite of claim 1, wherein sheath of the core/sheath polyester fiber bond to the high crimp polyester fiber.

6. The high loft nonwoven composite of claim 1, wherein the nonwoven layer has a density of between about 0.65 and 4.0 g/cm³ and a thickness of between about 2 and 10 mm.

7. (canceled)

8. The high loft nonwoven composite of claim 1, wherein the core/sheath polyester fiber comprises fibers of between about 2 and 15 denier.

9. The high loft nonwoven composite of claim 1, wherein the core/sheath polyester fiber comprises fibers with a staple length of between about 1 and 4 inches.

10. The high loft nonwoven composite of claim 1, wherein the thermoplastic layer is applied to the nonwoven layer by the process selected from the group consisting of extrusion coating, extrusion lamination, hot melt lamination, pressure sensitive lamination, adhesive powder, adhesive scrim, and coating adhesive liquid.

11. The high loft nonwoven composite of claim 1, wherein the thermoplastic layer comprises a polymer selected from the group consisting of TPO, polyvinyl chloride, polyurethane, any others, and mixtures thereof.

12. The high loft nonwoven composite of claim 1, wherein the thermoplastic layer is embossed with a leather simulation pattern.

13. The high loft nonwoven of composite claim 1, wherein the sheath of the core/sheath polyester fiber has a melting temperature of about 90 to 110° C.

14. (canceled)

15. A high loft nonwoven composite comprising:
a nonwoven layer having a first and second side comprising
about 60 to 90% by weight of a high crimp polyester fiber having between
about 5 and 20 crimps per inch, and
about 10 to 40% by weight of a core/sheath polyester fiber, wherein the sheath has a lower melting temperature than the core,
wherein the nonwoven layer is heat set;
a fabric selected from the group consisting of knit, woven, and nonwoven needled onto the first side of the nonwoven layer and,
a thermoplastic layer applied to the fabric on the side opposite the nonwoven layer.

16. The high loft nonwoven composite of claim 15, wherein the high crimp polyester fibers are hollow.

17. The high loft nonwoven composite of claim 15, wherein the high crimp polyester fiber further includes a silicon containing coating.

18. (canceled)

19. The high loft nonwoven composite of claim 15, wherein sheath of the core/sheath polyester fibers bond to the high crimp polyester fiber.

20. The high loft nonwoven composite of claim 15, wherein the nonwoven layer has a density of between about 0.65 and 4.0 g/cm³ and a thickness of between about 2 and 10 mm.

21. The high loft nonwoven composite of claim 15, wherein the thermoplastic layer comprises a polymer selected from the group consisting of TPO, polyvinyl chloride, polyurethane, any others, and mixtures thereof.

22. The high loft nonwoven composite of claim 15, wherein the thermoplastic layer is embossed with a leather simulation pattern.

23. (canceled)

24. The high loft nonwoven composite of claim 15, wherein the nonwoven layer is calendared on at least one side.

25. A high loft nonwoven composite comprising:
a nonwoven layer having a first and second side comprising
about 60 to 90% by weight of a high crimp polyester fiber having between about 5 and 20 crimps per inch, and
about 10 to 40% by weight of a core/sheath polyester fiber, wherein the sheath has a lower melting temperature than the core,
wherein the nonwoven layer is heat set;
a binder layer applied to the nonwoven layer on the first side of the nonwoven layer, and;
a surface textile selected from the group consisting of knit, woven, and nonwoven applied to the binder layer on the side of the binder layer opposite the nonwoven layer.

26. The high loft nonwoven composite of claim 25, wherein the high crimp polyester fibers are hollow.

27. The high loft nonwoven composite of claim 25, wherein the high crimp polyester fiber further includes a silicon containing coating.

28. (canceled)

29. The high loft nonwoven composite of claim 25, wherein the nonwoven layer has a density of between about 0.65 and 4.0 g/cm³ and a thickness of between about 2 and 10 mm.

30. The high loft nonwoven of composite claim 25, wherein sheath of the core/sheath polyester fibers bond to the high crimp polyester fiber.

31. The high loft nonwoven composite of claim 25, wherein the nonwoven layer is calendared on at least one side.
